(19) United States
(12) Patent Application Publication
(10) Pub. No.: US 2005/0033549 A1
(43) Pub. Date: Feb. 10, 2005

(54) Rollover sensing using tire pressure sensor

(75) Inventor: Jeffrey A. Clark, Macomb Township, MI (US)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO automotive Corporation, Auburn Hills, MI (US)

(21) Appl. No.: 10/895,681

(22) Filed: Jul. 21, 2004

Related U.S. Application Data
(60) Provisional application No. 60/490,409, filed on Jul. 25, 2003.

(51) Int. Cl. G01C 9/00

(52) U.S. Cl. 702/150; 701/124

(57) ABSTRACT

The system includes pressure sensors disposed within tires of a vehicle. Vehicle maneuvering produces changes in tire pressure between the various tires. The rate and magnitude of changes in tire pressure are utilized to verify and determine vehicle orientation. Changes in tire pressure and the rate of change for the tires provides information utilized for detecting orientation of the vehicle and sensing possible roll over conditions.

### BACKGROUND OF THE INVENTION

This application claims priority to U.S. Provisional Application No. 60/490,409 which was filed on Jul. 25, 2003.

This invention relates generally to a method of sensing vehicle orientation. More particularly, this invention relates to a method of sensing changes in tire pressure to sense a roll over condition.

Vehicle safety is always a concern and additional systems are continually being developed to improve safety. One such system detects conditions indicative of vehicle roll over. Typically, a roll over detection system utilizes an acceleration sensor and/or an angular rate sensor that communicates information indicative of vehicle orientation. The use of electronic sensing can in some instances provide a false indication of a specific condition or orientation. Safing is a term of art that is applied to the use of redundant or secondary sensors to confirm and verify information obtained from a primary sensor. Other systems and sensors within the vehicle are utilized to provide information that verifies and confirms the data provided by a primary system.

Typical vehicle dynamic control systems that detect and anticipate potential roll over conditions include an acceleration sensor that provides information indicative of vehicle acceleration along a specific axis. Acceleration along a vertical axis provides information that is used to determine if the vehicle is approaching a roll over condition. Acceleration sensors are complex and costly devices that require specific programming and calibration. It is desirable to utilize sensors capable of providing information for several different systems. However, typically, an acceleration sensor for sensing acceleration along a specific axis does not provide information useful for other vehicle systems.

Tire pressure monitoring systems have been developed and will soon be required equipment. A tire pressure monitoring system provides information indicative of tire pressure and other tire conditions to a controller mounted within the vehicle. The controller utilizes the information from the tire pressure sensors to monitor tire conditions and alert an operator to conditions outside of desired parameters. Currently, tire pressure sensors provide information for only the tire pressure monitoring system. As appreciated, it is beneficial to use information gathered from any vehicle system for more than one purpose.

Accordingly, it is desirable to develop a system that can monitor tire pressure and provide information utilized for vehicle dynamic control systems.

### SUMMARY OF THE INVENTION

This invention is a method of monitoring and determining vehicle orientation utilizing tire pressure sensors to detect dynamic changes in tire pressure.

The system includes pressure sensors disposed within tires of a vehicle. The information indicative of tire conditions from the tire pressure sensors is utilized to determine vehicle dynamic conditions. The tire pressure sensors are capable of detecting relatively small changes in tire pressure within each of the tires, and to detect potential leaks and conditions that can cause improper tire inflation. Changes in tire pressure also results from movement of the vehicle. As the vehicle moves, the load distribution moves from side to side and forward to back causing corresponding changes in loads on the individual tires. The changes in load on each tire cause a corresponding change in tire pressure. Quick dynamic changes in tire pressure as monitored by the tire pressure sensors and are therefore indicative of dynamic changes to vehicle orientation. Changes in tire pressure and the rate of changes for each tire is utilized for detecting orientation and for sensing a roll over conditions.

Accordingly the system of this invention utilizes dynamic tire pressure information provided by the tire pressure monitoring system to detect vehicle dynamic conditions.

These and other features of the present invention can be best understood from the following specification and drawings, the following of which is a brief description.

### BRIEF DESCRIPTION OF THE DRAWINGS

FIG. 1 is a schematic view of a vehicle including a tire pressure monitoring system.

FIG. 2 is a schematic view of the vehicle illustrating axes of movement.

FIG. 3 is a schematic view of a vehicle tipped toward one side.

FIG. 4 is a schematic view of forces on a vehicle traversing a curve.

FIG. 5 is a force diagram illustrating forces on a vehicle traversing a curve.

### DETAILED DESCRIPTION OF THE PREFERRED EMBODIMENT

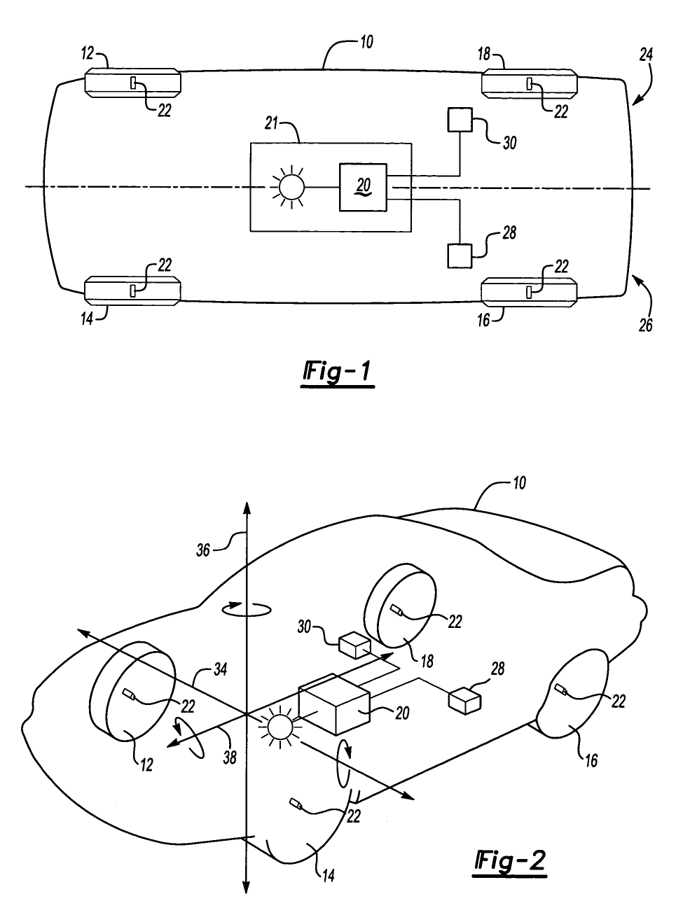

Referring to FIG. 1, a vehicle 10 includes tires 12, 14, 16, and 18 disposed at each corner. Each of the tires 12, 14, 16 and 18 includes a tire pressure sensor 22. The tire pressure sensor 22 senses information indicative of conditions within each of the tires 12, 14, 16 and 18 and communicates that information to a controller 20. The tire pressure sensor 22 and the controller 20 comprise the tire pressure monitoring system schematically shown at 21. The controller 20 utilizes information from the tire pressure sensor 22 to alert a vehicle operator of conditions outside desired parameters.

Referring also to FIG. 2, the vehicle 10 also includes sensors for monitoring vehicle orientation. The sensors include an angular rate sensor 28 and an acceleration sensor 30. Both the angular rate sensor 28 and the acceleration sensor 30 are shown, however, some system utilize one or the other to provide the desired information concerning vehicle orientation. The orientation of the vehicle 10 includes movement about a lateral axis 34, a vertical axis 36 and a longitudinal axis 38. As appreciated, movement about the lateral axis 34 is pitch, movement about the vertical axis 36 is yaw, and movement about the longitudinal axis 38 is roll. Movement of the vehicle 10 about these axes produces vehicle-handling characteristics that are monitored to alert a driver to specific operating conditions. The angular rate sensor 28 and acceleration sensor 30 provide specific information concerning vehicle movement and orientation that is not readily adaptable for use in determining other parameters that are desirable to be observed. The controller 20 is shown schematically and can include a dedicated controller 20 for each system or a portion of a vehicle controller that controls many different aspects of vehicle operation.

The tire pressure monitoring system 21 of this invention utilizes information from the tire pressure sensors 22 to determine vehicle orientation. The tire pressure sensors 22 are capable of detecting relatively small changes in tire pressure within each of the tires 12, 14, 16 and 18 to detect potential leaks and conditions indicative of improper tire inflation.

Changes in tire pressure also results from movement of the vehicle. As the vehicle moves the distribution of vehicle load moves from side to side and forward to back causing corresponding changes in loads on the individual tires 12,14,16 and 18. The changes in load on each tire 12,14,16, and 18 causes a corresponding change in tire pressure. The change in tire pressure monitored by the tire pressure sensors 22 is therefore indicative of vehicle orientation.

Changes in tire pressure for each of the tire 12, 14, 16 and 18 provides the information necessary for detecting orientation of the vehicle 10 as a verification of other sensors, such as the angular rate sensor 28 and acceleration sensor 30. Further, the changes in tire pressure can also me utilized independently to provide information concerning the current vehicle orientation. Advantageously, no additional hardware is required. The controller 20 includes an additional algorithm for analyzing the tire pressure information provided by tire pressure sensors 22 provided from the tires 12, 14, 16 and 18.

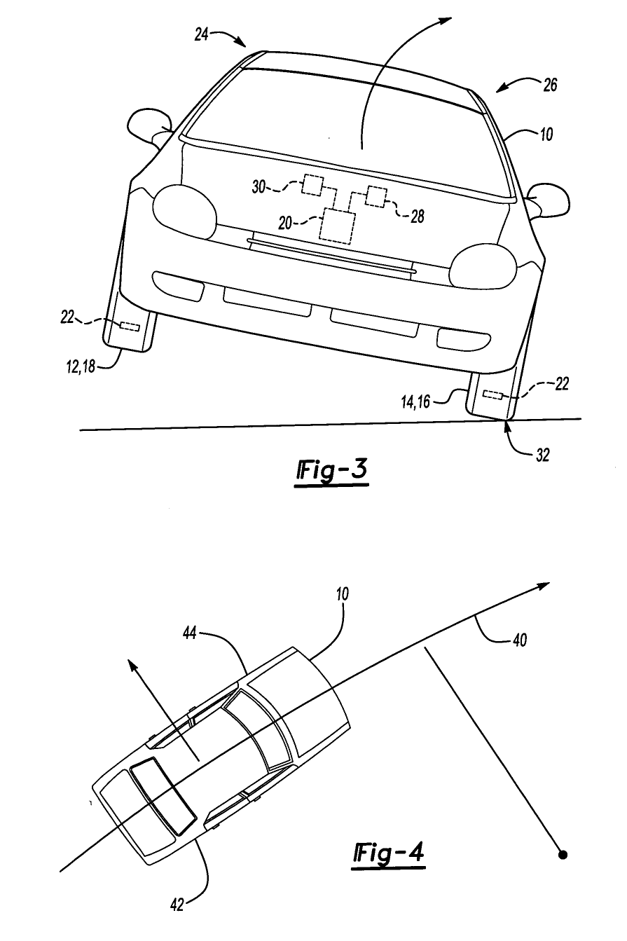

Referring to FIG. 3, the vehicle 10 is shown in a potential roll over condition. As appreciated the position of the vehicle 10 is exaggerated for example purposes. In a rollover condition, the tires 14,16 on a right side 26 carry substantially the entire load of the vehicle 10. The tires 12,18 on a left side 24 carry no load. The example illustrated is extreme to illustrate the differences in tire pressure resulting in roll over conditions. In practice, it is desirable to detect subtler changes in tire pressure between each of the sides 24,26 to anticipate and correct a roll over condition.

The tires 14,16 in a roll over condition experience a drastic and quick rise in pressure. In contrast, the tires 12,18 experience a drastic and quick decrease in pressure. The controller 20 receives this information from the tires 12, 14, 16 and 18 and determines that the vehicle 10 is in a roll over condition, as well as the direction of the potential roll over. This information is utilized either to verify the information communicated from the angular rate sensors 28 and the acceleration sensor 30 or to enhance the overall detectability or performance of the roll over sensing function. The vehicle orientation information provides relevant information required for actuating vehicle dynamic control devices such as active suspension components and brakes to anticipate and correct undesirable vehicle orientations and/or actuate airbags to protect vehicle occupants.

The controller 20 is programmed to include an algorithm to interpret the information received from the tire pressure sensors 22. Preferably, the controller 20 is a commonly available microprocessor that a worker versed in the art with the benefit of this disclosure would be able to program to perform the inventive method. The method of this invention includes the initial step of determining the relationship between tire pressures within each of the tires 12,14,16, and 18 at a desired vehicle orientation. As appreciated, the desired vehicle orientation will include a range of acceptable tire pressures and differences in tire pressure representative of typical operating conditions. Once a baseline of acceptable tire pressures and differences in pressure between the various tires at various locations on the vehicle 10 is determined a deviation from that baseline will result in a determination that the vehicle 10 has departed from the desired orientation.

Further, the controller 20 will recognize extreme changes in tire pressure over a specified time. The magnitude of a change in tire pressure is coupled with the rate of the change or the time within which such a change occurs. A change in tire pressure within a relatively small period is indicative of an extreme change to vehicle orientation. Changes in tire pressure include several different parameters that are measured and utilized for any determination. These parameters include change in tire pressure, rate of any changes, changes between tire pressure at different locations on the vehicle, magnitude of a difference in pressure and specific magnitudes of changes within a predetermined period. As appreciated, it is within the contemplation of this invention that tire pressure data received by the controller 20 can be related to other vehicle conditions and into different forms that provide information indicative of vehicle conditions and for sensing potential roll over conditions.

A deviation from a desired vehicle orientation in the example embodiment for a rollover condition will be signaled in response to a difference between tire pressure in tires on the right side 24 relative tire pressures for tires on the left side 26. The magnitude of the difference and departure from acceptable differences indicate the severity of the vehicle orientation. Additionally, a lateral roll over condition is indicated by a sudden quick change in tire pressure. Changes in tire pressure that occur within a predetermined time coupled with a measurement of the magnitude of the changes provide for sensing of a potential roll over condition.

The period within which such a difference occurs is considered to determine if the vehicle is approaching a roll over condition along with providing a safing function. Monitoring the rate of pressure change within a predetermined time provides an indication of whether the vehicle is approaching a roll over condition. Monitoring how quickly the changes in tire pressure occur provides for the recognition of conditions in which a vehicle may tip and loads shifted when not in a roll over conditions, such as, for example, when changing a tire. Quick dynamic change in tire pressure is detected and utilized for sensing a roll over condition.

Additionally, detection of a roll over condition is indicated in response to an increase in pressure within a predetermined period for tires on a common side of the vehicle 10. An increase in pressure above a predetermined threshold value within a predetermined period indicates that the vehicle 10 is either in a roll over condition or in a condition anticipatory of excessive roll of the vehicle. The specific pressure change and rate that is indicative of a roll over condition depends on vehicle size; tire size, and other operational factors such as speed and orientation of the vehicle. Further, a roll condition can also be detected responsive to a drastic, quick decrease in tire pressure for tires on a common side of the vehicle.

Referring to FIG. 4, a vehicle 10 is schematically illustrated traversing a curve 40. As the vehicle 10 moves around the curve 40, loads are distributed and shifted from an inner side 42 of the vehicle 10 to an outer side 44 of the vehicle 10.

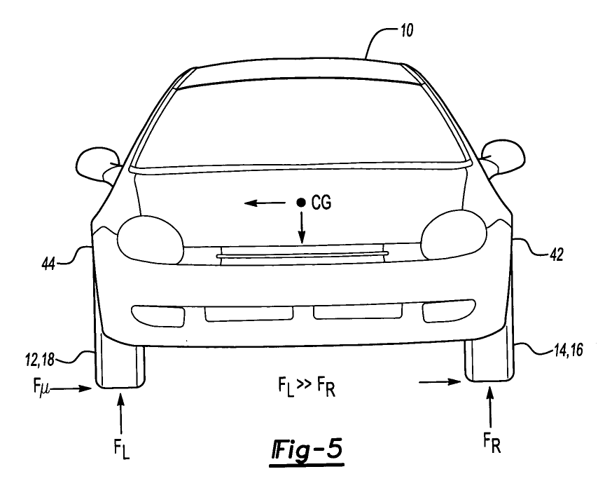

Referring to FIG. 5, a force diagram is shown that illustrates the shifting of forces acting on the vehicle 10 during movement through the curve 40. As the vehicle traverses the curve 40 the center of gravity CG of the vehicle 10 moves toward the outer side of the curve 44. The forces F_{L} on the tires 12,18 and the forces F_{R} on the tires 14, 16 change with the shift of the center of gravity CG. The loads on the vehicle 10 shift and are redistributed relative to the changes in the position of the center of gravity. The shifting of loads on the tires results in the forces F_{L} becoming much greater than the forces F_{R}. The result of the shifting of forces from one side to another on the tires the 12, 18 and 14, 16 is that air pressure within the tires change indicating a change in vehicle orientation.

The method of detecting orientation of the vehicle 10 includes the steps of sensing a pressure within tires of the motor vehicle; and determining an orientation of the motor vehicle based on the pressure sensed within the tires 12,14,16, and 18 of the vehicle 10. Pressure in each of the tires 12,14,16, and 18 is continually sensed and communicated to the controller 20. Pressure information for each of the tires 12,14,16, and 18 may be sent continually or at pre-selected intervals. The controller 20 compares the actual pressure information with a threshold value that is indicative of a desired vehicle orientation. The desired vehicle orientation can include a position where the load of the vehicle is distributed evenly across the tires 12,14,16, and 18. As appreciated, a desired vehicle orientation can include different criteria depending on application specific requirements.

During operation, a sudden change in tire pressure that is outside expected parameters will indicate a departure from the desired vehicle orientation. The indication can be by way of a difference between pressure within tires 12,14,16, and 18 on opposite sides of the vehicle 10 that exceeds a predetermined threshold value or an individual pressure within one of the tires 12,14,16, and 18 that exceeds a threshold value for that individual tire.

In an example embodiment, a difference in pressure between tires 12,18 on the left side 24 and tires 14, 16 on the right side 26. The rate of change in tire pressure along with the magnitude of change is compared to threshold values. The threshold value is a rate of change in tire pressure that has been determined to indicate a deviation from a desired vehicle orientation. If the rate of changes in tire pressure exceeds the threshold value an alert is initiated. The nature of an alert can be to warn the operator, or to actuate vehicle systems including roll over airbag deployment according to predefined criteria.

The controller 20 can recognize the specific departure of the vehicle 10 from a desired condition. Monitoring each of the tires 12,14,16, and 18 provides an indication of how loads are shifting within the vehicle 10. The shifting of loads within the vehicle 10 is not only present from side to side, but also from front to back. A difference between tires on opposite sides of the vehicle is indicative of roll of the vehicle 10 about the longitudinal axis 38. Further, most often the shifting of loads on the vehicle will consist of a combination side-to-side and front to back redistributions of vehicle load. The controller 20 includes algorithms to sort through such redistribution in loads and determine the current vehicle orientation as it relates to the desired vehicle orientation. Accordingly, information received from the tire pressure sensors 22 of each of the tires 12,14,16, and 18 produces a quick and accurate indication of vehicle orientation.

This invention also includes a method of calibrating the tire pressure monitoring system 21 to determine and recognize a vehicle orientation. The method includes the initial step of determining a rate of change in tire pressure that indicates a departure from a desired vehicle orientation. An alternate vehicle orientation is determined that corresponds to a specific rates of change in tire pressure and how the changes in tire pressure are distributed over the tires 12, 14, 16 and 18. The method further includes the step of alerting an operator, or actuating a vehicle safety system such as an airbag in response to changes in tire pressure at a rate and magnitude indicative of a deviation from the desired vehicle orientation.

The alternate vehicle orientations include conditions that are indicative of a roll over of the vehicle, and less drastic deviations from the desired vehicle orientation that can impact vehicle-handling characteristics. Deviations are detected by determining a difference and rate of change in tire pressures for tires on opposite sides of the vehicle. When the difference and rate of change is greater than a threshold value, an alternate vehicle orientation is indicated. The controller 20 is preprogrammed to recognize differences in pressure between each and combinations of the tires 12, 14, 16 and 18 and the alternate vehicle orientations that produce such differences. A worker versed in the art with the benefit of this disclosure would understand how to program the controller 20 to recognize the vehicle orientations that correspond to the differences in tire pressures.

The system of this invention provides for the detection and monitoring of vehicle orientation utilizing a tire pressure monitoring system. The use of the tire pressure monitoring system to monitor and a sense vehicle orientation provides an increased efficiency by increasing the number of vehicle parameters communicated by the tire pressure sensor disposed in each tire. The change in tire pressure that occurs during operation of the vehicle is utilized to monitor and anticipate actions of the automobile. Further, the tires of a vehicle are a basic component and provide a quick reliable indication of vehicle maneuvering. The tire pressure for a given vehicle is constant within certain limits and resulting changes in tire pressure caused by changes in vehicle orientation are also predictable. The predictability reduces calibration requirements and time while providing increase reliability.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of detecting orientation of a vehicle comprising the steps of:
(a) sensing a pressure within tires of the vehicle; and
(b) determining an orientation of the vehicle based on changes of said pressure sensed within the tires of the vehicle.

2. The method as recited in claim 1, wherein said vehicle includes a plurality of corners and said step (a) includes sensing changes in pressure within tires at different corners of the vehicle.

3. The method as recited in claim 1, wherein said step (b) includes determining a change in pressure between tires at different corners of the vehicle.

4. The method as recited in claim 3, wherein said step (b) includes determining that the vehicle is in potential roll over condition responsive to a difference in pressure between the tires being greater than a predetermined value.

5. The method as recited in claim 1, wherein said step (b) includes determining that the vehicle is in a potential roll over condition responsive to a rate in change in pressure greater than a threshold value for tires on a common side of the vehicle.

6. The method as recited in claim 1, wherein said step (b) includes determining that the vehicle is in a potential roll over condition responsive to a changes in pressure greater than a threshold value for tires on a common side of the vehicle.

7. The method as recited in claim 1, wherein said step (b) includes determining a distribution of weight of the vehicle based on the pressure within the tires.

8. The method as recited in claim 1, including the step of confirming a determination of vehicle orientation generated by a sensing system within the vehicle.

9. The method as recited in claim 8, wherein said sensing system determines vehicle orientation based on an acceleration of the vehicle.

10. The method as recited in claim 8, wherein said sensing system determines vehicle orientation based on values generated by an angular rate sensor.

11. A method of calibrating a tire pressure monitoring system comprising:
(a) determining a desired vehicle orientation based on a pressure value for a tire; and
(b) determining an alternate vehicle orientation corresponding to a deviation from the pressure within the tire from that pressure value corresponding to the desired vehicle orientation.

12. The method as recited in claim 11, including the step of determining a desired response to a determination of the alternative vehicle orientation.

13. The method as recited in claim 11, wherein said desired response includes alerting an operator of said alternative vehicle orientation.

14. The method as recited in claim 11, wherein said step (b) includes determining a plurality of alternative vehicle orientations corresponding to differing deviations of pressure within the tire from the pressure value corresponding to the desired vehicle orientation.

15. The method as recited in claim 14, wherein one of said plurality of alternative vehicle orientations includes a condition indicative of a vehicle approaching a roll over.

16. A detection assembly for a vehicle comprising:
a plurality of pressure sensors disposed within a corresponding plurality of tires; and
a controller for receiving information indicative of tire pressure from said plurality of pressure sensors, and for determining an orientation of the vehicle based on said information indicative of tire pressure.

17. The assembly as recited in claim 16, wherein the vehicle includes a first side and a second side, and at least one of said plurality of tires is disposed on each of said first and second sides of the vehicle.

18. The assembly as recited in claim 17, wherein said controller determines a rate of change in tire pressure between tires disposed on each of said first and second sides.

19. The assembly as recited in claim 18, wherein said controller determines a roll over condition responsive to said rate of change in tire pressure being greater than a predetermined value.

20. The assembly as recited in claim 18, wherein said controller determines a direction of vehicle acceleration based on said rate of change in tire pressures being greater than a predetermined value.
